(19) United States
(12) Patent Application Publication
(10) Pub. No.: US 2003/0204442 A1
(43) Pub. Date: Oct. 30, 2003

(54) Scanning and voiding method and apparatus for processing coupons

(76) Inventor: Robert Marshall, Las Cruces, NM (US)

Correspondence Address: Bell, Boyd & Lloyd LLC, P.O. Box 1135, Chicago, IL, 60690-1135, US

(21) Appl. No.: 10/134,085

(22) Filed: Apr. 25, 2002

(51) Int. Cl. G06F 17/60

(52) U.S. Cl. 705/14; 235/462.43

(57) ABSTRACT

The present invention relates to a coupon processing system and method that includes a scanner and a voider, where the system enables a user to process coupons at or near a coupon redemption location. The system scans codes on coupons using one or more scanners. The codes on the coupons are transferred to a processor and the processor determines if each coupon was scanned properly. If the coupon is not scanned properly, the coupon is separated into a non-scan coupon group. If the coupon is successfully scanned, the coupon is transferred to a voider which voids the coupon to prevent mal-redemption and re-circulation of the coupons. The non-scan coupons are sent to another location for further processing. The scanned coupons are stored in a secure area at the coupon redemption location or at a secure off-site storage area.

### BACKGROUND OF THE INVENTION

Coupons are a valuable part of a multi-billion dollar consumer promotional industry that provide coupon issuers such as manufacturers and other entities with a way to enhance marketing of goods and services. Additionally, coupons provide cash discounts to consumers on various goods and services. Coupons are one of the most popular promotional tools used by manufacturers to support their packaged goods brands and are also a highly valued tool for consumers as an effective means of saving money on groceries, household goods and services.

Consumers use several billion coupons annually in making purchases of such goods and services. Since these coupons are virtual currency, coupon processors deploy complex procedures to ensure proper redemption and to determine accurate payment and billing data. Valuable promotion performance information is gathered from the redeemed coupons, and after analysis, reported to the coupon issuers in order to assess program effectiveness. FIG. 1 generally illustrates the primary known coupon processing system used in the United States.

Referring to FIG. 1, coupon processing begins with the customer or consumer 100. A coupon redeemer 102 such as a retail store, redeems one or more coupons presented by the customer 100. In return, the customer 100 receives cash discounts on products and/or services from the coupon redeemer for the products and services associated with the redeemed coupons. The coupon redeemer 102 provides the cash discount to the customer 100 based on the value of the particular coupon and the products or services that the customer purchased from the coupon redeemer. By providing customers with a cash discount, the coupon redeemer incurs a cash liability or debt for the total value of the coupons that the coupon redeemer accepted or redeemed from the customers. The cash debt, plus a coupon handling fee for correctly redeemed coupons, is owed to the coupon redeemer by the coupon issuers for the particular coupons redeemed by the coupon redeemer.

The coupon redeemer collects all of the redeemed coupons and periodically ships them with an invoice for the face value of the coupons and handling fees, to a coupon clearinghouse 104, which acts as the coupon redeemer's or store's agent. The coupons are shipped on a daily, weekly, monthly or other suitable time period usually determined by the volume of coupons redeemed by the coupon redeemer. Some retailers may ship coupons directly from individual stores, while others may consolidate store coupons at a central location and ship in bulk. In any event, the logistics and shipping costs of forwarding coupons to the clearinghouse represent a significant cost to the coupon redeemer, especially if the redeemer processes large volumes or if the redeemer is geographically distant from the clearinghouse location. Additionally, the time period between when the coupon redeemer ships its coupons and invoices to the coupon clearinghouse, and when the clearinghouse actually receives the coupons and invoices will vary based on the actual submittal method. The method of shipment may be altered depending upon prevalent financial conditions that affect the cost of carrying debt. In a high interest environment, for example, the coupon redeemer may even ship by air freight to reduce the cost of carrying extended receivables.

The coupon clearinghouse 104 represents the interests of the coupon redeemer 102 by assuring proper management of the coupon redeemer's accounts receivable. This is a very complex task because there are several thousand different coupon issuers and a shipment may contain coupons from any one of these issuing entities. It is not unusual for the receivables roster to have more than 500 separate line items. Although the coupon redeemer receives a single payment, the clearinghouse recovers this consolidated disbursement by billing each of the issuing sources individually.

Coupon clearinghouses use quite sophisticated processing systems to sort and process the coupons received from coupon redeemers. Today, most coupons carry core information in bar codes formatted according to approved Industry standards. The codes on each coupon are scanned at the clearinghouse and validated against authenticated codes established by the coupon issuer. The processed coupons are separated into two primary groups. The scanned and validated coupon group, from which all data has been captured and verified, and the non-scan coupon group containing coupons that were not readable or were read but had codes indicating the need for special handling. These special codes may indicate a particular promotion such as a free goods offer that has a variable coupon value, or that the coupon must be retained and returned to the issuer as is the case with sweep stakes entry coupons. Such coupons need specialized processing as compared to regular or normal coupons.

Non-scan coupons either have no bar code, have a bar code of poor optical quality, or contain errors within the bar code. These coupons are not successfully scanned because of the defective bar code condition. Defective bar codes may also result from damage through mishandling. Such coupons that typically have physical defects such as a tear, wrinkle or mark in the code portion of the coupon, will not scan and are also included in the non-scan group. All coupons in the non-scan group need special handling, normally requiring a manual process, at the coupon clearinghouse in order to correct the data input or comply with the specific handling condition as indicated by the special code. After the coupon processing is completed, the clearinghouse forwards the coupons and associated billing invoices to each respective coupon issuer's agent 106.

The coupon issuer's agent represents the interests of the coupon issuer and ensures that the amount due to the coupon redeemer is substantially accurate and that the coupon shipment is substantially free of mal-redemption (i.e., the submitted coupons were properly accepted and used to purchase valid products). The coupon issuer's agent manages and reports the promotion performance data from the coupons to respective coupon issuers using computerized data analysis to assist the issuer in managing present and future coupon promotions. Typically, the coupon issuer's agent enters the coupon redemption data into an on-line analysis and reporting system and bills the coupon issuer for the face value of the coupons that the coupon issuing agent adds the service and handling fees, and includes the cost of freight for shipping the coupons. Once the coupon issuer's agent receives payment from the coupon issuer, the agent disperses the funds owed to the coupon clearinghouse and to the coupon redeemer according to pre-negotiated payment terms or payment terms consistent with generally accepted industry practices. In the known coupon processing system, there is generally a period of time between the collection of accounts receivable by the coupon redeemer or store, and the disbursement of the accounts payable by the coupon issuers. This time lag in the coupon processing system results in significant cash liabilities and cost of money expense for the coupon redeemers and coupon clearinghouses, and delays and distorts real-time promotion performance information that is vital to marketing in terms of intelligence, and to finances in terms of remnant liability on active promotions.

The coupon processing system illustrated in FIG. 1, which is the system typically used in the United States, is characterized as a two-step process because the functions and responsibilities of the coupon clearinghouse and a coupon issuer's agent are clearly separated. Recently in the United States, the incorporation of extended bar codes on coupons, coupled with the development of improved scanning and coupon processing systems, have enabled certain coupon issuers and/or their agents in the United States, to move to a one-step process for capturing all data essential to service the needs of both the coupon redeemers and the coupon issuers. This means that all of the required processing information on each individual coupon (i.e., financial and marketing data) is captured in a single scanning process. This one-step process permits the collective capture of coupon redemption data and promotion performance data by the coupon clearinghouse. This has obviously resulted in some simplification of coupon handling practices and reduced the cycle time of the overall process, but the roles of the clearinghouse and issuers agent remain strictly separate. The latter must still enforce the terms and conditions as stated on each coupon, authenticate the viability of the coupon redeemer, ensure that the coupons have been properly redeemed, rigidly control the proprietary performance information derived for each coupon issuer and ensure secure disposition of the redeemed coupons.

Despite the advantages of the one-step data capture process, there is still a significant time lag with respect to the cash flow and data transfer between coupon redeemers and coupon issuers since the actual coupon handling for the clearing process still occurs at great distances from the coupon redemption locations. The cost of shipping all of the coupons from the coupon redemption location to a coupon clearinghouse is still very expensive and time consuming. Moreover, with the conversion to the one-step process, clearinghouses have had to develop and install complex embellishments to their processing systems to more accurately process all coupons and adopt very stringent manual processes for handling non-scanned coupons in order to satisfy the increasing needs of the coupon issuers and the coupon redeemers. Many of the coupon clearinghouses have established operations in foreign countries such as Mexico. Although this minimizes labor costs, higher shipping costs are incurred and time delays worsened due to extended transportation times, complex export requirements and delays due to transition complications at the border crossings.

Therefore, there is a pressing need for an improved coupon processing system that moves the processing point closer to coupon redeemer sites, that reduces the payment cycle time between coupon redeemers and coupon issuers, accelerates the delivery of promotion performance data related to issued coupons, prevents the mal-redemption and re-circulation of coupons, and reduces ever increasing coupon shipping costs associated with coupon movement.

### SUMMARY OF THE INVENTION

The present invention provides a coupon processing system and more specifically, a method and apparatus for processing coupons redeemed at or near the site of the coupon redeemer such as a retail store. The system of the present invention enables coupons to be processed at or near a coupon redemption location, reduces costs associated with coupon transfer to distant locations, minimizes the overall time needed to complete the coupon process and generates and delivers final promotion performance data to the coupon issuers. In essence, this processing system saves coupon issuers, coupon redeemers, and the intermediate processing agents significant time and money by accurately processing and voiding the codes on the coupons at or near the point of redemption. Thus, the present invention inhibits mal-redemption and recirculation, accelerates the transfer of promotion performance data to coupon issuers, decreases the payment cycle time, decreases the cost of money by reducing the financial cycle time and significantly reduces coupon shipping costs.

In one embodiment, the coupon processing system of the present invention includes a coupon processing apparatus having a housing; a computer including a processor, which is connected to the housing; a scanner or code reader in communication with the processor and connected to the housing; and a voider in communication with the processor and connected to the housing. The coupons are fed or transferred into an opening in the housing and transported by the scanner or code reader. The scanner reads each coupon and transfers the data captured from the coupons on to the processor. The processor analyzes the data and determines whether the code was properly read by the scanner. If the code on a coupon cannot be read after one or more attempts (such as a predetermined number of attempts), that coupon is determined to be a non-scan and is separated into a non-scan coupon group or batch (i.e., non-scans). This normally small group of non-scan coupon is forwarded for finish processing to a coupon clearinghouse.

In some cases, it will be obvious to the machine operator that no attempt should be made to scan the coupon. This occurs in cases where the coupon has no bar code, the bar code is blatantly marked or damaged, or the physical characteristics of the coupon are not conducive to easy passage through the scanner. Coupons that are printed on foil or plastic are in this later category because they tend to curve and coil at the edges. Also, many so-called instant on-pack coupons (i.e., coupons attached to a package) have an adhesive residue causing clumping. As a result, these coupons stick together, such that immediate separation is virtually impossible. Thus, an important part of the process is that a trained machine operator makes a quick decision as to whether to attempt a coupon scan based on a rapid visual inspection for any coupons showing the above defects or features. Such coupons having these defects or difficult features are placed immediately into a non-scan coupon group without any actual scan attempt. This pre-inspection initiative considerably increases the efficiency of the process of the present invention.

If the coupon is successfully scanned and validated, the capture code is transferred to the processor. The processor includes computer files having special codes related to special offers provided by the coupon issuer such as offers for free goods or services or sweepstakes entry coupons that carry consumer name and address information. Codes indicative of these special coupons are previously downloaded to the system, via a modem, satellite system or similar device, from a database located at the central coupon clearinghouse. These codes contain information specific and confidential to each coupon issuer. The special codes are compared to the codes scanned from the coupons to determine if each coupon includes one or more of these special codes. If a coupon includes a special code, the coupon is separated and placed into the non-scan coupon group.

All of the coupons in the non-scan coupon group are temporarily stored at the coupon redemption location, or other local secure storage area, and then shipped to a coupon clearinghouse or to a secure off-site facility for further specialized processing. An identification tag is generated and printed by the system of the present invention to identify and track each batch of non-scan coupons for auditing and to enhance the integrity of the entire coupon processing cycle. The separation of non-scans at or near the redemption location of the coupon redeemer, instead of at the coupon clearinghouse, substantially reduces the number of coupons that need to be shipped to the coupon clearinghouse, saving significant shipping and handling costs.

Coupons that are scanned and validated and do not include a special code, are transported from the scanner to the voider. The voider voids or invalidates the coupons in a suitable manner so that the coupons cannot be re-scanned, re-used or re-circulated by a shopper or accepted by a coupon redeemer. This step virtually eliminates any possibility of mal-redemption, adding significant integrity and financial security to the process. In one embodiment, the voider prints a full black line, at or nearly parallel to the linear elements of the bar code, that fully intersects the entire vertical span of the bar code. In this condition, the bar code cannot be read by the scanner. In other embodiments, the voider incorporates a hole puncher that removes one or more full linear elements of the bar-code. Further embodiments, include any other marking or code degradation device that destroys the readability of the bar code but retains full physical integrity of the coupon such that the coupons can still be visually interpreted as required in later audits. Once the coupons are voided, they are moved to a temporary storage area and readily accessible if a subsequent audit becomes necessary. In one embodiment, a temporary, but secure, storage area is established within the coupon redemption location. In another embodiment, the voided coupons are stored near the coupon redemption location such as in a secure off-site storage facility. Once a predetermined auditing period ends, the coupons are destroyed using a suitable device such as a shredder or pulverizer.

In other embodiments, one or more additional components are connected to the housing of the coupon processing system of the present invention so that coupons can be processed more efficiently. In one embodiment, a prompter such as an audio device is connected to the system and emits a distinctive audio acknowledgment indicating that all information has been successfully captured from the coupon. Alternatively, the absence of this prompt may serve to alert the operator that the code has not been captured or contains a special code and is a non-scan. In another embodiment, several distinct audio prompts are used to indicate different types of coupons and special coupon codes.

Prompting is very effective in ensuring that the operator has a clear understanding of the status of each coupon. In the case of a non-scan, the operator either re-scans the coupon or places it immediately to the non-scan group. In the case of an acceptance prompt the coupon is automatically voided, and subsequently placed in the scanned coupons group. This prompting system helps significantly in ensuring that the coupons are added to the correct stacks. In another embodiment, multiple scanners and voiders are used in the system to enable coupons to be fed past the scanners in any orientation or direction. In one embodiment, the scanners scan each side of the coupons as the coupons pass by the scanners. This embodiment enables a user to rapidly process coupons so that larger volumes of coupons may be processed at or near a coupon redemption location.

In another embodiment, all components are minimized in size and weight, and battery powered such that the apparatus is highly portable and independent of any utilities. This version of the apparatus can be moved quickly from location to location and used on a coupon processing route either by bringing the coupons into a vehicle housing the processing system, or more preferably by moving the portable version system into the retail premises and handling coupons on site. Either way, the coupons can be processed by this single machine at several locations during the day.

In a further embodiment, an automatic feeder and associated transport devices are connected to the housing and used to feed the coupons into the coupon processing apparatus of the system. In one embodiment, a diverter or sorter flap is attached or connected to the housing adjacent to the voider so that the scanned and non-scan coupons can be automatically sorted into separate groups in a continuous process. It is very important from an accuracy and integrity perspective that scanned and voided coupons be distinctly separated into one group and the non-scans, likewise, distinctly separated into another group. The sorter therefore enables the user to further enhance the efficiency of the process and more accurately maintain separation of the coupon groups.

In one embodiment, the coupon processing system of the present invention is a portable system so that coupon clearinghouses can process coupons at or near multiple coupon redemption locations and thereby enhance the speed, efficiency and deployment of coupon processing tasks. In another embodiment, the coupon processing system is transported to the coupon redemption location in a truck or similar vehicle where the coupon processing is performed in the vehicle or in the store. After the coupon processing is complete, the non-scannable coupons can be shipped or transported from at or near the coupon redemption location by the vehicle to the coupon clearinghouse and the scanned group moved to temporary storage.

In a further embodiment, the portable coupon processing system is attached to a cabinet or similar structure at the coupon redemption location. In this embodiment, additional attachments such as an automatic feeder can be connected to the system to enhance coupon processing. In another embodiment, the coupon processing apparatus of the system is enclosed in a cabinet or similar housing and maintained at the coupon redeemer. In this manner, a clearinghouse can process coupons at each coupon redeemer and a clearinghouse does not have to bring a portable system to each coupon redemption location.

It is therefore an advantage of the present invention to provide a coupon processing system for processing coupons redeemed by a coupon redeemer at or near a coupon redemption location.

Another advantage of the present invention is to provide a coupon processing system that can be transported to or near a coupon redemption location.

A further advantage of the present invention is to provide a coupon processing system for separating scanned and non-scan coupons at or near a coupon redemption location.

A further advantage of the present invention is to provide a coupon processing system where coupon codes can be transferred directly to a remote location from at or near a coupon redemption location.

Another advantage of the present invention is to provide a coupon processing system that voids coupons.

A further advantage of the present invention is to provide a coupon processing system that automatically flags coupons that require special handling.

A further advantage of the present invention is to provide a coupon processing system that processes large volumes of coupons efficiently.

A further advantage of the present invention is to provide a coupon processing system that scans, voids, identifies and stores redeemed coupons at or near a coupon redemption location.

Additional features and advantages of the present invention are described in and will be apparent from, the following Detailed Description of the Invention and the figures.

### BRIEF DESCRIPTION OF THE FIGURES

FIG. 1 is a schematic diagram illustrating a prior art coupon redemption process.

FIG. 2 is a schematic diagram illustrating one embodiment of the system of the present invention where one or more coupons are processed using the system.

FIG. 3 is a schematic diagram illustrating the operation of the system of FIG. 2.

FIG. 4 is an enlarged front view of a voided coupon.

FIG. 5 is a schematic diagram illustrating another embodiment of the system of the present invention where the system includes an audio prompter.

FIG. 6 is a schematic diagram illustrating a further embodiment of the system of the present invention where the system includes two scanners and two voiders.

FIG. 7 is a schematic diagram illustrating another embodiment of the system of the present invention where the system includes additional components.

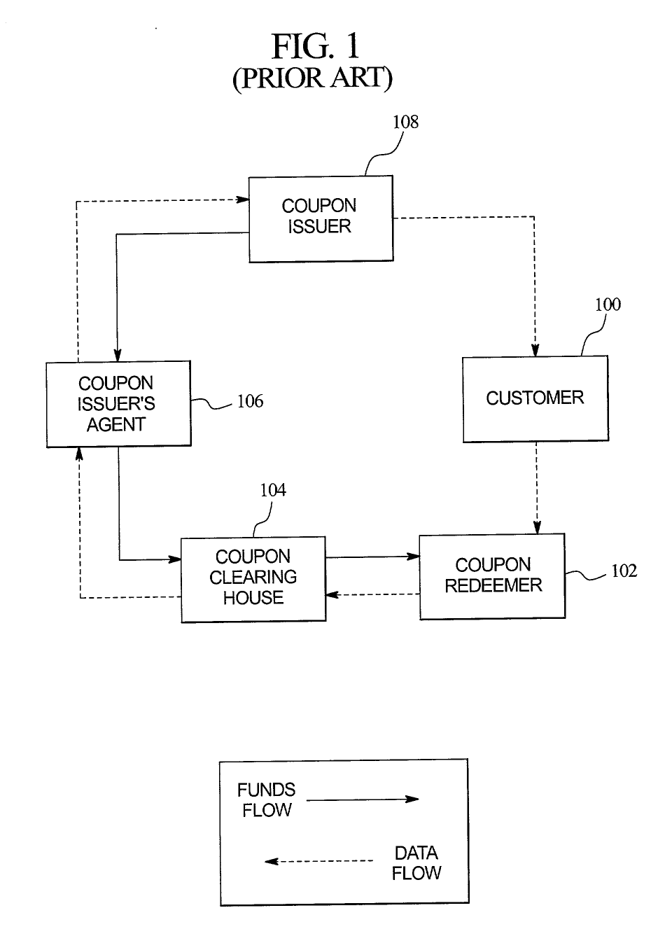

### DETAILED DESCRIPTION OF THE INVENTION

The present invention relates to a coupon processing system and method for processing coupons redeemed by a coupon redeemer at or near a coupon redemption location.

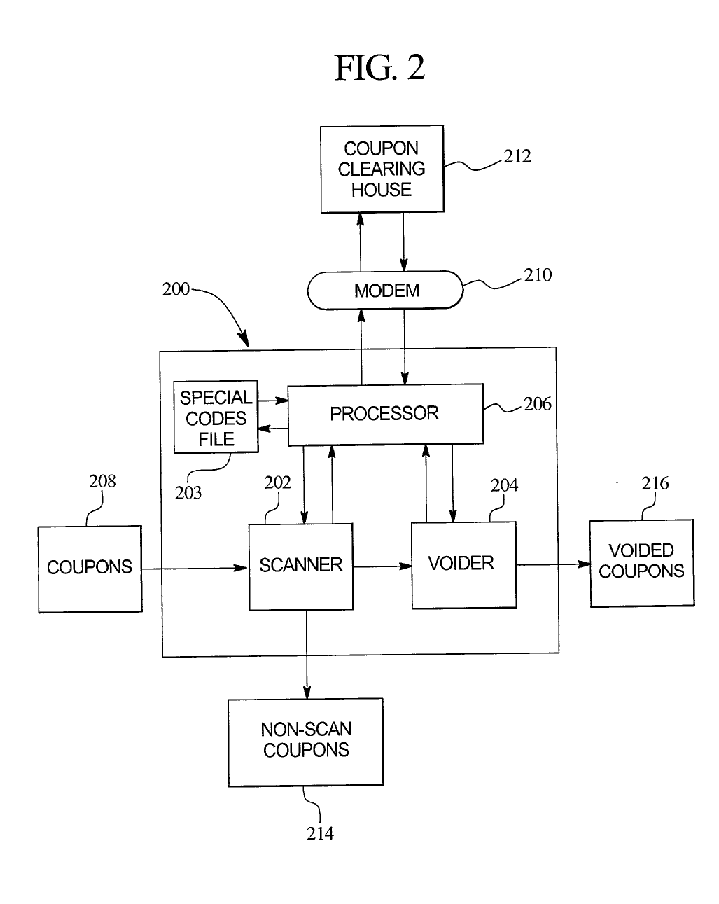

Referring now to FIGS. 2 through 4, one embodiment of the coupon processing system and method of the present invention is illustrated where an apparatus 200 enables users to process coupons redeemed by a coupon redeemer at a coupon redemption location such as a retail store or similar entity, accelerates the transfer of promotion performance data to coupon issuers, segregates coupons that require special handling, decreases the payment cycle time, prevents mal-redemption and re-circulation of coupons, and reduces coupon shipping and handling costs associated with coupon processing. The coupon processing apparatus 200 includes a housing (not shown), a processor 206 connected to the housing, a scanner 202, a voider 204 and a segregation file 203 containing special coupon codes or flags, where each component is connected to the housing and in communication with the processor.

The scanner or code reader 202 is a device that scans each coupon and more specifically, the encoded data or code of or on each coupon such as a bar code. The scanner 202 scans the code on the coupon by using a laser or other suitable scanning technology. The scanner then communicates the code to the processor 206, which analyzes and records the code from each coupon in a storage medium. The storage medium, for instance, may be a random access memory, read-only memory, compact disk read-only memory, magnetic disk or a network. It should be appreciated that the code on each coupon may include any suitable type of data desired by the coupon issuer such as the product description, U.P.C. code, extended U.P.C. code, manufacturer name, coupon discount price, and the expiration date of the coupon.

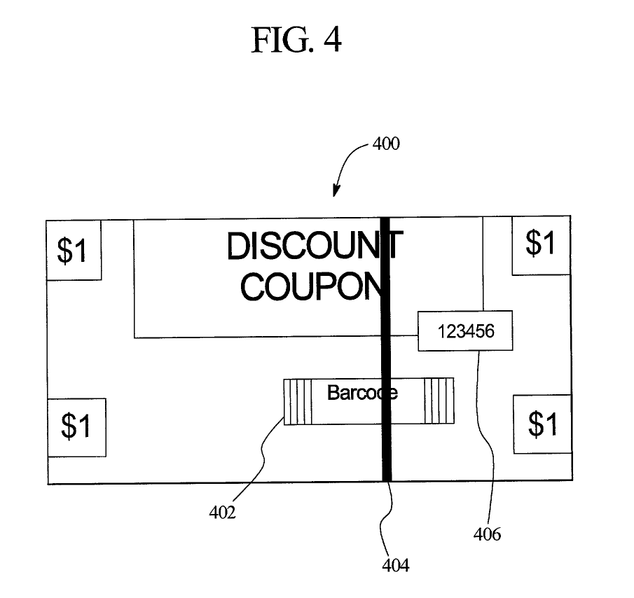

The voider, or voiding unit, 204 communicates with the processor 206 and voids or invalidates a coupon after the coupon bar code data is fully captured and validated by the scanner 202. The voider 204 only voids coupons that have been successfully scanned and validated in their entirety by the scanner 202. By voiding the scanned coupons, the voider prevents mal-redemption and re-circulation of the coupons. In one embodiment, the voider includes a printer such as an inkjet printer that prints a voiding line or stripe that vertically intercepts the entire width of the bar code. FIG. 4 shows an example of a voiding line 404 that has been printed on a coupon 400. The voiding line 404 clearly indicates that the coupon has been redeemed by a coupon redeemer and voided. In other embodiments, the voider 204 includes a mechanical hole puncher or slicer that physically cuts out a section of the coupon vertically across the bar code so that the code is no longer readable and cannot be used again by a customer or by a coupon redeemer. It should be appreciated that the voider may be any suitable device that properly voids a coupon. In a further embodiment, the voider prints an audit sequence number 406 on the coupon (as shown in FIG. 4), so that a particular coupon or group of coupons can be tracked and located for auditing or some other purpose at a later time.

Referring to FIG. 2, the processor communicates with the scanner 202, the special codes file 203 and the voider 204, and also with a computer network (not shown) located at a coupon clearinghouse 212 via a modem 210, satellite system (not shown) or other suitable communication device. Using the modem 210, the processor 206 downloads information, such as special coupon codes, from the computer network at the coupon clearinghouse. The processor 206 also uploads information, such as promotion performance data, to the computer network at the coupon clearinghouse. Thus, the efficient exchange of information between the coupon redeemer and the coupon clearinghouse decreases the payment cycle time and accelerates the transfer of the promotion performance data to the coupon issuer.

The special coupon codes are stored in files on the computer network located at the coupon clearinghouse center. These special codes are downloaded from the computer network at the coupon clearinghouse and are used to further process the redeemed coupons. The special codes are compared to the code or codes scanned by the scanner 202 in apparatus 200. If the scanned codes are special codes, then the coupons containing the special codes are separated and batched, form a sub-group of the non-scans, and are retained for final finish processing at the coupon clearinghouse. As stated above, the separation of the coupons with the special codes is typically performed at the coupon clearinghouse. The system and method of the present invention separates the scanned and non-scan coupons at the coupon redemption location, which further reduces the coupon processing time and associated shipping and handling costs.

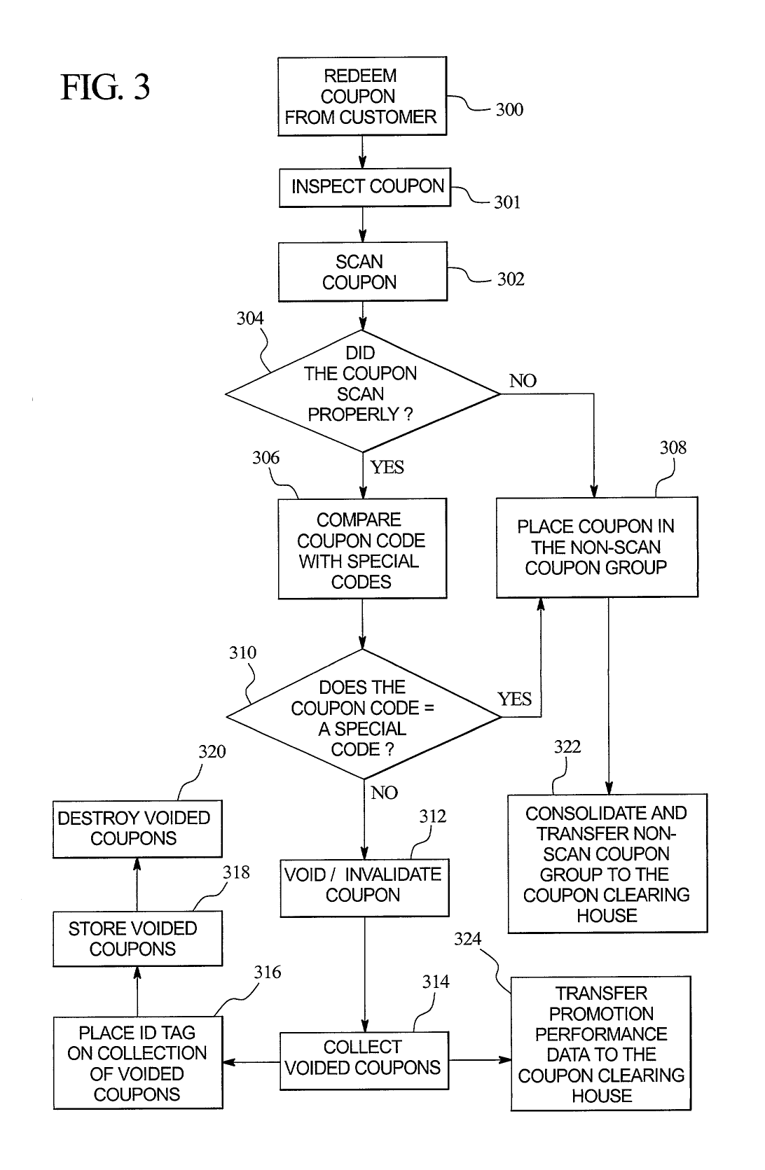

Referring to FIG. 3, operation of the system and method of the present invention in FIG. 2 is illustrated in more detail. Coupons are presented by a customer or consumer to a coupon redeemer for cash discounts on goods and/or services. Contrary to the conventional coupon processing systems described above, the coupon processing system of the present invention can be transported to a coupon redeemer or maintained at or near the location of the coupon redeemer. In this manner, coupon processing begins promptly and eliminates the lag times and costs associated with shipping the coupons to a coupon clearinghouse. As described in detail below, the time and costs for shipping coupons to a coupon clearinghouse are significant. In the present system, the redeemed coupons are fed into the apparatus 200 at or near the coupon redemption location. In one embodiment, the coupons are manually fed into the coupon processing apparatus 200. In another embodiment, the coupons are automatically fed into the apparatus using a suitable or conventional automatic feeder or similar device. If on visible inspection, step 301, coupons show obvious defects, the coupons are immediately placed into the non-scan coupon group (308) without any scanning attempt. The vast majority of coupons, however, that are introduced to the apparatus 200, have a regular bar code printed on each of the coupons. The scanner 202 scans the bar code as indicated by block 302 and captures and relays the data to the processor. The processor determines if the code was scanned properly by the scanner as indicated by diamond 304.

If the coupon code is damaged (such as being wrinkled or torn), defective, voided or not readable for some other reason, the code is not properly scanned and the processor signals the user to place the non-scanned coupon into the group or batch of non-scan coupons 214 (i.e., non-scans) as indicated by block 308. If the code on the coupon is successfully and properly scanned by the scanner, the processor compares the scanned code with special codes, which are stored in computer files downloaded from the computer network located at the coupon clearinghouse as indicated by block 306. The processor then determines whether the scanned code matches one or more special codes as indicated by diamond 310. Coupons including special codes indicate unique offers or errors on a coupon. Examples include free coupons, variable value coupons, expired coupons, those that contain consumer name and address information, or have misinformation errors due to incorrect printing. It should be appreciated that special codes can indicate any type of offer desired by the coupon issuer and may include special codes introduced by the clearinghouse in order to add insight or efficiency into the coupon clearing process. Some coupons may be flagged and separated for special audit reasons or as evidence in a potential fraud situation. If the scanned code matches one or more of the special codes, the coupons are separated into the non-scan coupon group as indicated by block 308. A distinctively different audio prompt could be used to alert the operator that this particular coupon has been successfully scanned but contains a special code. This permits easier sub-grouping of special code coupons within the non-scan group. If the scanned code does not match any of the special codes, the coupon is transported to the voider 204. It is possible that sub-batching or further separation of the non-scan coupon group could add efficiency to the final processing. For example, separate groups of plastic, variable value, or sweepstake coupons could be handled more easily in the subsequent manual process.

The coupons that are properly scanned are transported to a voider, which is preferably adjacent to the scanner. The voider 204 invalidates or voids the properly scanned coupons as indicated by block 312. In one embodiment, the voider prints a vertical stripe or line fully across the code to invalidate the coupon. The stripe may be printed using a suitable printer such as inkjet printer. In another embodiment, the voider is a mechanical hole puncher that imparts a hole that fully eliminates at least one complete linear element of the bar code, thus rendering the code non-readable if re-presented at a checkout scanner. Voiding inhibits mal-redemption and/or re-circulation of the coupons, which enhances the integrity of the present coupon processing system. It should be appreciated that other suitable voiding devices and methods may be employed with the coupon processing apparatus of the present invention.

Once the coupons are voided, they are collected and batched at or near the coupon redemption location as indicated by block 314. The apparatus 200 prints an identification tag, which includes information such as, store identification, processed date, coupon batch number, coupon identification number, audit sequence number and other suitable information, as indicated by block 316. The identification tag is attached to the batch or group of voided coupons so that the coupons can be identified and located for subsequent auditing or some other purpose at a later time. The voided coupons are stored temporarily in a secure area at the coupon redemption location or at a secure off-site storage area, for a predetermined period of time. Once the auditing period has ended, the coupons are destroyed as indicated by block 320 so that the coupons cannot be redeemed again or re-circulated. The coupons are typically destroyed using a shredder, pulverizer or similar device.

The coupons that are not scanned or include a special code, are sorted into the non-scan coupon group as indicated by block 308. These coupons are similarly identified as to origin, tagged and then shipped to a coupon clearinghouse for manual processing. In one embodiment, the non-scan coupons are stored in a secure area at the coupon redemption location prior to being shipped to the coupon clearinghouse. In another embodiment, the non-scan coupons are stored in a secure off-site storage area near the coupon redeemer. In a further embodiment, the coupon processing system of the present invention is transported and maintained inside of a truck or similar vehicle. In this case, coupons can be brought into the vehicle for processing or since the system can be built with easy portability, it may be carried into the facility of the redeemer and coupons handled on their site. The coupons are processed in the vehicle or at the redeemer site using the coupon processing system of the present invention. The non-scan coupons can be stored at or near the coupon redemption location and then shipped to the coupon clearinghouse. Also, the non-scan coupons can be stored in the vehicle and transported to a secure off-site storage area or to the coupon clearinghouse by the vehicle.

After the coupons are processed, the processor generates a linking number such as a task number, which is printed by a suitable printer and associated with the non-scan coupons so that the non-scan coupons and the scanned coupons from a particular coupon redeemer, can be linked together at a later time. The step of separating and storing the non-scan coupons associated with a coupon redeemer is significant because under the present invention, only the non-scan coupons must be shipped to the coupon clearinghouse or off-site storage location. The non-scan coupons are generally less than 5% of all the coupons shipped to coupon clearinghouses or other locations from coupon redeemers. This huge volumetric reduction obviously translates into enormous savings in shipping and handling. Also, a significant amount of time is saved because only the non-scans are processed at the coupon clearinghouses, instead of all of the coupons from the different coupon redeemers. Once the non-scan coupons arrive at the coupon clearinghouse, they are immediately processed as described above.

The processor saves the codes scanned from the coupons in a storage or recording medium. The storage medium may be any suitable storage medium including, but not limited to, a random access memory, a read-only memory, a compact disk read-only memory, a magnetic disk or a network. The stored codes are analyzed and subsequently used to compile promotion performance data on the central processor at the coupon clearinghouse. Additionally, the processor generates an invoice based on the processed coupons using suitable software loaded in the apparatus 200. The invoice may be printed on a suitable printer connected to the computer and in communication with the processor. All of the data can then be uploaded to the computer network at the coupon clearinghouse immediately by using a modem, satellite system, or similar communication device. In this manner, the promotion performance data compiled by the processor can be transferred to the coupon issuer much quicker than in the conventional systems and the summarized financial data used to adjust the remaining liability of each coupon promotion. This step enables coupon issuers to plan further optimal coupon promotions and more accurately allocate financial reserves to cover remaining liability. Also, the invoices can be uploaded or downloaded as needed, which significantly reduces the payment cycle time between the coupon issuer and the coupon redeemer and minimizes the cost of deployed capital.

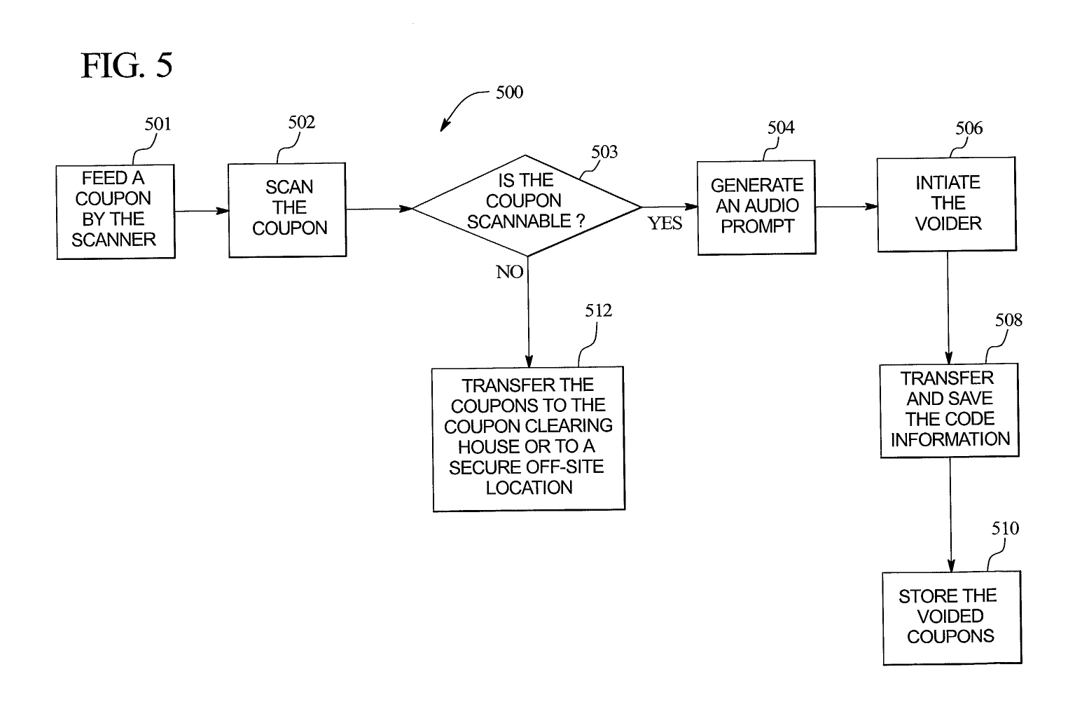

Referring now to FIG. 5, another embodiment of the apparatus of the present invention is illustrated where an audio prompt is integrated into the coupon processing system 500. In this embodiment, each coupon is fed into the system and scanned by a scanner as indicated by blocks 501 and 502. The processor determines whether a coupon is scanned as indicated by diamond 503. If the entire data is captured and validated from the coupon bar code, an acceptance prompt, such as an audio prompt, is generated as indicated by block 504. This alerts the operator of the system that the coupon data is captured, fully validated and recorded in a memory device. The prompt also serves to initiate the voider mechanism that destroys code readability as indicated by block 506. If no acceptance prompt is generated, the coupon must be re-scanned or placed in the non-scan coupon group. As described above, in another embodiment, several distinct audio prompts are used to indicate different types of coupons and special coupon codes. For example in one embodiment, a distinct audio prompt is used to alert a user that a coupon has been successfully scanned and a different audio prompt is used to indicate that the successfully scanned coupon includes a special code. Once the coupon is invalidated or voided, the information scanned from the code on the coupon is transferred and saved by the processor as indicated by block 508. The coupon is then stored at or near the coupon redemption location with other scanned coupons for a predetermined period of time to be audited, if necessary, as indicated by block 510. If the processor fails to capture data from the coupon or detects a special code as indicated by diamond 503, the coupon is added to the non-scan group. These non-scans are batched, tagged and sent to the coupon clearinghouse or secure off-site location as indicated by block 512. The coupon clearinghouse performs further processing of the non-scan coupons to accurately capture the necessary data.

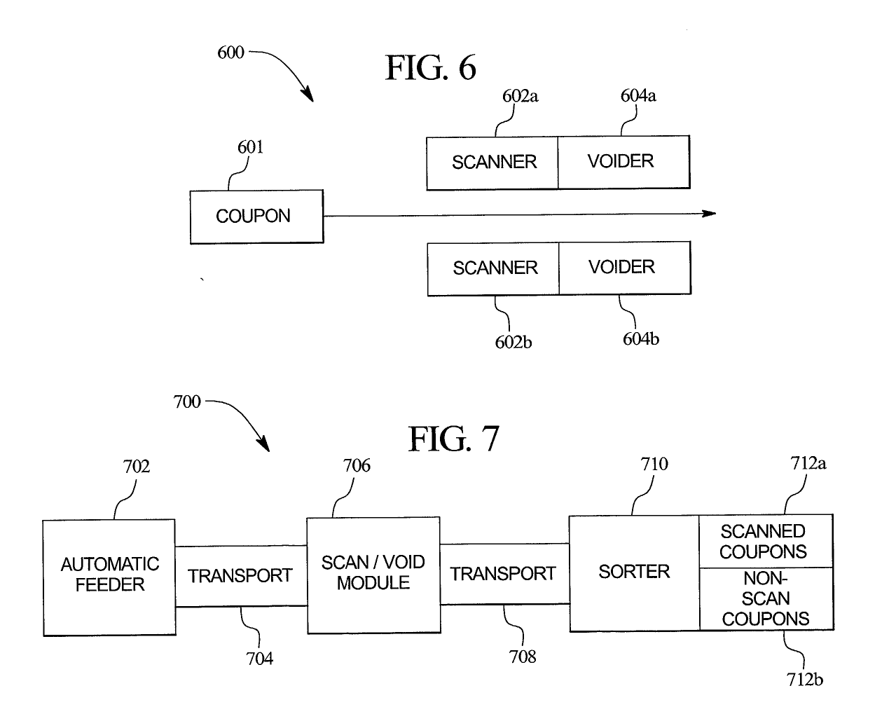

In FIG. 6, a further embodiment of the present invention is illustrated where the coupon processing system includes two scanners and two voiders so that either side of a coupon can be read by the apparatus 600. In this embodiment, each coupon 601 is fed into the apparatus 600 regardless of the orientation or position of the coupons. Thus, the coupons are processed much quicker and more efficiently. The scanner 602a and voider 604a are mounted on one side of the apparatus 600 and the scanner 602b and voider 604b are mounted opposite to and facing scanner 602a and voider 604b. Although the scanners and voiders are shown as sequential components in FIG. 5, the scanner and voider essentially occupy the same space in the apparatus to ensure that the void line always fully intercepts the bar code or encoded data on the coupons. Therefore, as each coupon 601 passes by and between the scanners 602 and voiders 604, the scanners scan each side of the coupon 601 and obtain the necessary codes or coded information from the coupon. It should be appreciated that a single voider may be used in this embodiment where the voider operates on either side of the coupons. All scanned coupons are voided or invalidated by the voiders 604a and 604b and then collected and stored in a secure area at or near the location of the coupon redeemer.

Referring to FIG. 7, another embodiment of the system of the present invention is illustrated where additional components are attached to the coupon processing apparatus 700 to further enhance the processing capabilities of the system. In this embodiment, the apparatus 700 includes an automatic feeder 702, transports 704 and 708, a sorter 710, and bins to accumulate scanned coupons 712a and non-scans 712b. To accommodate the additional components, the portable scan/void module 706 can be adapted to attach to a stationary cabinet or other suitable fixture at the coupon redemption location.

The automatic feeder 702 may be any suitable automatic feeder that feeds coupons into the scan/void module 706. In one embodiment, a user places all the coupons in any order or orientation into the automatic feeder 702 and the automatic feeder moves the coupons on to the transport in a continuous stream and past the scan/void module 706. In another embodiment, the coupons are placed either face up or face down and in the same orientation into the automatic feeder 702 and then fed into the scan/void module 706.

Transports 704 and 708 transport or transfer the coupons between the individual components in the apparatus 700 so that the coupons are processed efficiently and expediently. The scan/void module 706 is preferably apparatus 200 as shown in FIG. 2. The diverter or sorter 710 diverts and separates scanned coupons 712a from non-scans 712b. The sorter may be any suitable type of sorter including a flap, which directs the coupons into separate groups or piles. After the sorter separates the coupons into the two groups, the processor generates a tracking identification number or job number that associates the two groups of the particular project or job. In this manner, the non-scanned coupons or non-scans, and the scanned coupons can be tracked and matched together at a later time if necessary. This is important because scanned coupons are stored in a secure on-site area or location whereas the non-scans are physically distant from the scanned coupons after being shipped to a coupon clearinghouse or a different secure off-site storage location for further processing. It should be appreciated that one or more of the additional components may be incorporated into the system of the present invention as desired.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for processing a plurality of coupons redeemed by a coupon redeemer, at or near a coupon redemption location, said method comprising the steps of:
(a) scanning a code on one of the coupons;
(b) transferring at least one captured code from the coupon to a processor;
(c) determining whether the captured code on the coupon was successfully or unsuccessfully scanned;
(d) directing the coupon into a non-scan group if the captured code on the coupon was unsuccessfully scanned;
(e) voiding the code on the coupon if the captured code on the coupon was successfully scanned;
(f) directing the voided coupon into a group of voided scanned coupons;
(g) repeating steps (a) to (f) for each of said plurality of coupons; and
(h) sending the group of non-scan coupons from at or near the coupon redemption location, to another location for manual processing.

2. The method of claim 1, wherein step (a) further includes the step of inspecting the coupons to detect whether the coupon includes a defective code or a non-scannable substrate before scanning the code on the coupon.

3. The method of claim 2, which further includes the step of directing the coupon into the non-scan group if the coupon includes a defective code or a non-scannable substrate.

4. The method of claim 1, which further includes the step of determining whether the coupon includes a special code, if the captured code on the coupon was successfully scanned, prior to step (g).

5. The method of claim 4, which includes the step of directing the coupon into the non-scan group if the coupon includes a special code.

6. The method of claim 4, which includes the step of emitting a signal when a successfully scanned code includes a special code.

7. The method of claim 1, which includes the step of emitting a signal when a captured code is successfully scanned.

8. The method of claim 1, which further includes the step of transferring data scanned from the codes on said plurality of coupons from the processor to a remote location via a communication device.

9. The method of claim 1, which further includes the step of transferring data scanned from the codes on said plurality of coupons from the processor to a remote location via a modem.

10. The method of claim 1, which further includes the step of transferring data scanned from the codes on said plurality of coupons from the processor to a remote location via a satellite system.

11. The method of claim 1, which includes the step of storing each code transferred to the processor on a storage medium.

12. The method of claim 11, wherein the storage medium is selected from the group consisting of: a random access memory, a read-only memory, a compact disk read-only memory, a magnetic disk and a network.

13. The method of claim 1, wherein the step of voiding the code on said coupon includes printing a line that is substantially parallel to and fully intercepts the linear elements of the bar code.

14. The method of claim 1, wherein the step of voiding the code on said coupon includes forming a hole that completely eliminates at least one full linear element of the bar code.

15. The method of claim 1, wherein the step of voiding the code on said coupon includes forming a slit that completely eliminates at least one full linear element of the bar code.

16. The method of claim 1, wherein the steps of directing said coupons are performed by a sorter.

17. The method of claim 1, wherein the step of scanning one of the coupons includes the step of feeding said coupon past a scanner using an automatic feeder.

18. The method of claim 1, which includes the step of storing the group of voided scanned coupons for a fixed period of time.

19. The method of claim 1, which includes the step of generating a identification tag to link the scanned coupon group and the non-scan coupon group of a specific group of coupons.

20. The method of claim 19, wherein the identification tag includes at least one of a batch number, a group number and an audit sequence number.

21. A method for processing a plurality of coupons redeemed by a coupon redeemer, at or near a coupon redemption location, said method comprising the steps of:
(a) inspecting one of the coupons to detect whether the coupons includes a defective code or a non-scannable code;
(b) directing the coupon into a non-scan group if the coupon includes a defective code or a non-scannable substrate;
(c) scanning the code on the coupon if the coupon does not include a defective code or a non-scannable substrate;
(d) transferring at least one captured code from the coupon to a processor;
(e) determining whether the captured code on the coupon was successfully or unsuccessfully scanned;
(f) directing the coupon into a non-scan group if the captured code on the coupon was unsuccessfully scanned;
(g) voiding the code on the coupon if the captured code on the coupon was successfully scanned;
(h) directing the voided coupon into a group of voided scanned coupons;
(i) repeating steps (a) to (h) for each of said plurality of coupons; and
(j) sending the group of non-scan coupons from at or near the coupon redemption location, to another location for manual processing.

22. The method of claim 21, which further includes the step of determining whether the coupon includes a special code, if the captured code on the coupon was successfully scanned, prior to step (g).

23. The method of claim 22, which includes the step of directing the coupon into the non-scan group if the coupon includes a special code.

24. The method of claim 21, which further includes the step of transferring data scanned from the codes on said plurality of coupons from the processor to a remote location via a communication device.

25. The method of claim 21, which includes the step of storing each code transferred to the processor on a storage medium.

26. A method for processing a plurality of coupons redeemed by a coupon redeemer, at or near a coupon redemption location, said method comprising the steps of:
(a) scanning a code on one of the coupons;
(b) transferring at least one captured code from the coupon to a processor;
(c) determining whether the captured code on the coupon was successfully or unsuccessfully scanned;
(d) directing the coupon into the non-scan group if the captured code on the coupon was unsuccessfully scanned;
(e) determining whether the coupon includes a special code if the captured code on the coupon was successfully scanned;
(f) directing the coupon into the non-scan group if the coupon includes a special code;
(g) voiding the code on the coupon if the captured code on the coupon was successfully scanned and did not include a special code;
(h) directing the voided coupon to a group of voided scanned coupons;
(i) repeating steps (a) to (h) for each of said plurality of coupons; and
(j) sending the group of non-scan coupons from at or near the coupon redemption location, to another location for manual processing.

27. The method of claim 26, wherein step (a) further includes the step of inspecting the coupon to detect whether the coupon includes a defective code or a non-scannable substrate before scanning the code on the coupon.

28. The method of claim 27, which further includes the step of directing the coupon into the non-scan group if the coupon includes a defective code or a non-scannable substrate.

29. The method of claim 26, which further includes the step of transferring data scanned from the codes on said plurality of coupons from the processor to a remote location via a communication device.

30. The method of claim 26, which further includes the step of transferring data scanned from the codes on said plurality of coupons from the processor to a remote location via a modem.

31. The method of claim 26, which further includes the step of transferring data scanned from the codes on said plurality of coupons from the processor to a remote location via a satellite system.

32. The method of claim 26, which includes the step of storing the codes transferred to the processor in a storage medium.

33. The method of claim 32, wherein the storage medium is selected from the group consisting of: a random access memory, a read-only memory, a compact disk read-only memory, a magnetic disk and a network.

34. The method of claim 26, wherein the step of voiding the code on said coupon includes printing a line that is substantially parallel to and fully intercepts the linear elements of the bar code.

35. The method of claim 26, wherein the step of voiding the code on said coupon includes forming a hole that completely eliminates at least one full linear element of the bar code.

36. The method of claim 26, wherein the step of voiding the code on said coupon includes forming a slit that completely eliminates at least one full linear element of the bar code.

37. The method of claim 26, wherein the steps of directing said coupons are performed by a sorter.

38. The method of claim 26, wherein the step of scanning one of the coupons includes the step of feeding said coupon past a scanner using an automatic feeder.

39. The method of claim 26, which includes the step of storing the group of voided scanned coupons for a fixed period of time.

40. The method of claim 26, which includes the stop of generating a identification tag to link the scanned coupon group and the non-scan coupon group of a specific group of coupons.

41. The method of claim 40, wherein the identification tag includes at least one of a batch number a group number and an audit sequence number.

42. A method for processing a plurality of coupons redeemed by a coupon redeemer, at or near a coupon redemption location, said method comprising the steps of:
(a) inspecting one of the coupons to detect whether the coupon includes a defective code or a non-scannable code;
(b) directing the coupon into a non-scan group if the coupon includes a defective code or a non-scannable substrate;
(c) scanning the code on the coupon if the coupon does not include defective code or a non-scannable substrate;
(d) transferring at least one captured code from the coupon to a processor;
(e) determining whether the captured code on the coupon was successfully or unsuccessfully scanned;
(f) directing the coupon into the non-scan group if the captured code on the coupon was unsuccessfully scanned;
(g) determining whether the coupon includes a special code if the captured code on the coupon was successfully scanned;
(h) directing the coupon into the non-scan group if the coupon includes a special code;
(i) voiding the code on the coupon if the captured code on the coupon was successfully scanned and did not include a special code;
(j) directing the voided coupon to a group of voided scanned coupons;
(k) repeating steps (a) to (j) for each of said plurality of coupons; and
(l) sending the group of non-scan coupons from at or near the coupon redemption location, to another location for manual processing.

43. The method of claim 42, which further includes the step of transferring data scanned from the codes on said plurality of coupons from the processor to a remote location via a communication device.

44. The method of claim 42, which includes the step of storing each code transferred to the processor on a storage medium.

45. A method for processing a plurality of coupons redeemed by a coupon redeemer, at or near a coupon redemption location, said method comprising the steps of:
(a) scanning a code on each coupon;
(b) transferring at least one captured code from each coupon to a processor;
(c) determining whether the captured code on each coupon was successfully or unsuccessfully scanned;
(d) directing each coupon into the non-scan group if the captured code on each coupon was unsuccessfully scanned;
(e) voiding the code on each coupon if the captured code on each coupon was successfully scanned;
(f) directing each voided coupon to a group of voided scanned coupons; and
(g) sending the group of non-scan coupons from at or near the coupon redemption location, to another location for manual processing.

46. The method of claim 45, wherein step (a) further includes the step of inspecting each coupon to detect whether the coupons include defective codes or non-scannable substrates before scanning the code on each coupon.

47. The method of claim 46, which further includes the step of directing each coupon into a non-scan group if the coupons include defective codes or non-scannable substrates.

48. The method of claim 45, which further includes the step of determining whether each scanned coupon includes a special code prior to voiding the code on each of said scanned coupons.

49. The method of claim 48, which further includes the step of separating each scanned coupon having a special code from the scanned coupons that do not have special codes.

50. The method of claim 49, which includes the step of directing each scanned coupon having a special code into the group of non-scan coupons.

51. The method of claim 45, which further includes the step of transferring data scanned from the codes on said coupons from the processor to a remote location via a communication device.

52. The method of claim 45, which further includes the step of transferring data scanned from the codes on said coupons from the processor to a remote location via a modem.

53. The method of claim 45, which further includes the step of transferring data scanned from the codes on said coupons from the processor to a remote location via a satellite system.

54. The method of claim 45, which includes the step of storing the codes transferred to the processor on a storage medium.

55. The method of claim 54, wherein the storage medium is selected from the group consisting of: a random access memory, a read-only memory, a compact disk read-only memory, a magnetic disk and a network.

56. The method of claim 45, wherein the step of voiding the code on each coupon includes printing a line that is substantially parallel to and fully intercepts the linear elements of the bar code.

57. The method of claim 45, wherein the step of voiding the code on each coupon includes forming a hole that completely eliminates at least one full linear element of the bar code.

58. The method of claim 45, wherein the step of voiding the code on each coupon includes forming a slit that completely eliminates at least one full linear element of the bar code.

59. The method of claim 45, wherein the steps of directing the coupons are performed by at least one sorter.

60. The method of claim 45, which includes the step of generating a identification tag to link the scanned coupon group and the non-scan coupon group of a specific group of coupons.

61. The method of claim 60, wherein the identification tag includes at least one of a batch number a group number and an audit sequence number.

62. A method for processing a plurality of coupons redeemed by a coupon redeemer, at or near a coupon redemption location, said method comprising the steps of:
(a) inspecting each coupon to detect whether the coupons include defective codes or non-scannable substrates;
(b) directing each coupon into a non-scan group if the coupons include defective codes or non-scannable substrates;
(c) scanning the code on each coupon if the coupons do not include defective codes or non-scannable substrates;
(d) transferring at least one captured code from each coupon to a processor;
(e) determining whether the captured code on each coupon was successfully or unsuccessfully scanned;
(f) directing each coupon into the non-scan group if the captured code on each coupon was unsuccessfully scanned;
(g) voiding the code on each coupon if the captured code on each coupon was successfully scanned;
(h) directing each voided coupon to a group of voided scanned coupons; and
(i) sending the group of non-scan coupons from at or near the coupon redemption location, to another location for manual processing.

63. The method of claim 62, which further includes the step of determining whether each scanned coupon includes a special code prior to voiding the code on each of said scanned coupons.

64. The method of claim 63, which further includes the step of separating each scanned coupon having a special code from the scanned coupons that do not have special codes.

65. The method of claim 64, which includes the step of directing each scanned coupon having a special code into the group of non-scan coupons.

66. The method of claim 62, which further includes the step of transferring data scanned from the codes on said coupons from the processor to a remote location via a communication device.

67. The method of claim 62, which includes the step of storing the codes transferred to the processor on a storage medium.

68. The method of claim 62, which includes the step of generating a identification tag to link the scanned coupon group and the non-scan coupon group of a specific group of coupons.

69. A coupon processing system comprising:
a scanner for scanning a plurality of coupons;
a voider adjacent to the scanner for voiding the scanned coupons; and
a processor in communication with the scanner and the voider which receives the codes from each coupon scanned by the scanner, determines whether the code on each of the coupons is a scanned code or a non-scanned code, causes each of the coupons having non-scanned codes to be directed into a non-scan coupon group, and causes the voider to void each of the properly scanned coupons.

70. The coupon processing system of claim 69, which includes a detachable feeder connected to the scanner for automatically feeding each of the coupons past the scanner.

71. The coupon processing system of claim 69, which includes a detachable sorter connected to the voider for separating voided coupons from non-voided coupons.

72. The coupon processing system of claim 69, which includes a prompter in communication with the processor for signaling when a coupon has been properly scanned and validated.

73. The coupon processing system of claim 72, wherein the prompter is an audio device.

74. The coupon processing system of claim 69, which includes a prompter in communication with the processor for signaling when a properly scanned and validated coupon includes a special code.

75. The coupon processing system of claim 74, wherein the prompter includes an audio device which emits a first signal when a coupon has been properly scanned and validated, and a second different signal when the coupon includes a special code.

76. The coupon processing system of claim 69, which includes a display device for displaying data scanned from the codes on each coupon.

77. The coupon processing system of claim 69, which includes a communication device which communicates with the processor to transfer data scanned from the codes on each of the coupons to a remote location.

78. The coupon processing system of claim 77, wherein the communication device includes a modem.

79. The coupon processing system of claim 77, wherein the communication device includes a satellite system.

80. The coupon processing system of claim 69, which includes a storage medium in communication with the processor for storing the data scanned from the codes on each of the coupons.

81. The coupon processing system of claim 80, wherein the storage medium is selected from the group consisting of: a random access memory, a read-only memory, a compact disk read-only memory, a magnetic disk and a network.

82. The coupon processing system of claim 69, wherein the voider includes a printer for marking each coupon.

83. The coupon processing system of claim 69, which includes a printer in communication with the processor.

84. A coupon processing system for processing a plurality of coupons, comprising:
a housing;
a scanner connected to the housing for scanning a plurality of coupons;
a voider connected to the housing and positioned adjacent to the scanner for voiding scanned coupons; and
a processor connected to the housing and in communication with the scanner and the voider for receiving the codes scanned by the scanner from each coupon, determining whether the codes on each of the coupons are scanned codes or non-scans, determining whether the scanned coupons include a special code, causing the non-scan coupons and coupons containing special codes to be directed into a non-scan coupon group, and causing the voider to void the coupons having scanned non-special codes.

85. A coupon processing system for processing a plurality of coupons, comprising:
a housing;
a first scanner connected to the housing;
a second scanner connected to the housing and positioned adjacent to the first scanner;
at least one voider connected to the housing and positioned adjacent to the first and second scanners for voiding coupons; and
a processor in communication with the first and second scanners and the voider wherein the processor causes the coupons to pass between the first and second scanners, receives codes from each coupon scanned by the first and second scanners, determines whether each code is a fully scanned code or a non-scanned code, determines whether the coupons having scanned codes include special codes, causes the coupons including special codes and non-scanned codes to be directed into a non-scan coupon group, and causes the voider to void the coupons having scanned non-special codes.
